(19) United States
(12) Patent Application Publication
(10) Pub. No.: US 2026/0236236 A1
(43) Pub. Date: Aug. 13, 2026

(54) APPLICATION MODIFICATION SYSTEM LEVERAGING LLM CAPABILITIES

(71) Applicant: SAP SE, Walldorf (DE)

(72) Inventors: Vickey Kumar SONI, Bengaluru (IN); Karthik Ravikumar, Bengaluru (IN)

(21) Appl. No.: 19/050,639

(22) Filed: Feb. 11, 2025

(51) Int. Cl. G06F 8/35; G06F 8/10; G06F 8/36

(52) U.S. Cl. CPC G06F 8/35; G06F 8/10; G06F 8/36

(57) ABSTRACT

System, method, and various embodiments for an application modification system, are described herein. An embodiment operates by receiving a user instruction to modify a data object, and identifying a plurality of applications to which the user has access. The data object is compared to the specification for at least a subset of the plurality of applications, and a first specification that includes the data object is identified. One or more requirements for performing the modification to the data object in accordance with first specification are identified. Feedback corresponding to the one or more requirements is received from the user. The API call to the first application is generated, and the data object of the first application is modified in accordance with the generated API call.

### BACKGROUND

Modifying an application, whether it is through modifying the code of the application, or customizing the application at runtime for a particular user or use case, is often a highly technical process that requires technological knowledge about the application, and as such, is beyond the capabilities of most users. However, users still need to modify the application to meet their needs. And thus, there is often a divide between a user's need to modify an application and the user's ability to understand the technical nature of the application well enough to perform the desired or required modification.

### BRIEF DESCRIPTION OF THE DRAWINGS

The accompanying drawings are incorporated herein and form a part of the specification.

FIG. 1 is a block diagram illustrating an example application modification system (AMS), according to some embodiments.

FIG. 2 is a flowchart illustrating example operations for providing an application modification system (AMS), according to some embodiments.

FIG. 3 is another flowchart illustrating example operations for providing an application modification system (AMS), according to some embodiments.

FIG. 4 is example user interface for providing functionality of an application modification system (AMS), according to some embodiments.

FIG. 5 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing an application modification system leveraging large language model capabilities.

Modifying an application, whether it is through modifying the code of the application, or customizing the application at runtime for a particular user or use case, is often a highly technical process that requires technological knowledge about the application, and as such, is beyond the capabilities of most users. However, users still need to modify the application to meet their needs. And thus, there is often a divide between a user's need to modify an application and the user's ability to understand the technical nature of the application well enough to perform the desired or required modification.

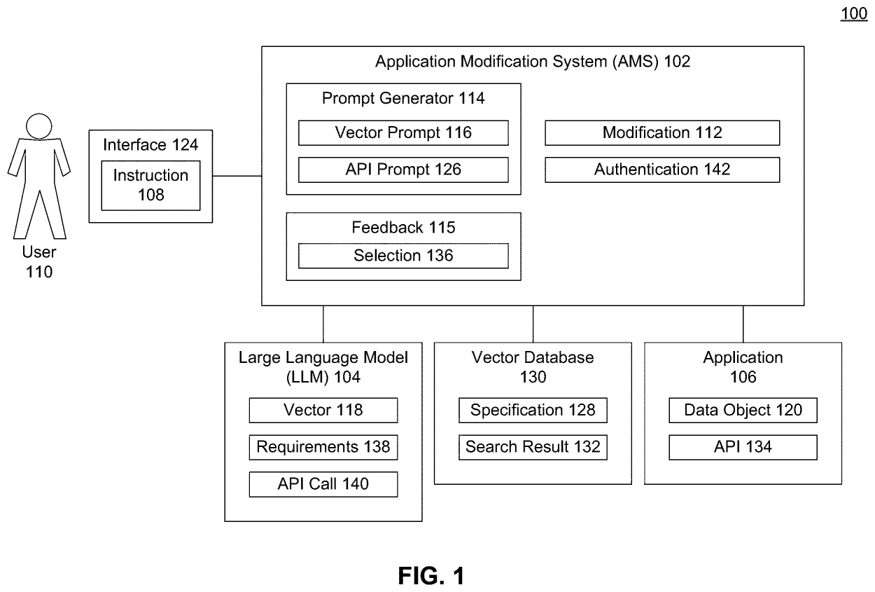

FIG. 1 is a block diagram 100 illustrating an example application modification system (AMS) 102, according to some embodiments. AMS 102 may leverage the capabilities of a large language model (LLM) 104 to modify an application 106 in accordance with an instruction 108 from a user 110. Rather than requiring the user 110 to understand the technical aspects of application 106, AMS 102 may allow the user 110 to simply provide a plain language instruction 108, while leveraging the capabilities of the LLM 104 to derive any information that would be necessary to perform a corresponding modification 112 to an application 106.

In some embodiments, AMS 102 may receive instruction 108 from a user 110 via an interface 124. The instruction 108 may include a plain language, non-computing language or non-programming language, input indicating what functionality the user 110 wants to add to the application 106, or how the user wants to modify one or more aspects of the application 106. For example, the user 110 may want to modify an existing data object 120 of the application 106, adding or removing one or more data fields.

While conventional methods of updating would require a developer to understand and code the modification in accordance with an application programming interface of the application, AMS 102 allows the user 110 to simply submit an instruction 108 using spoken language or text, without any knowledge of programming or a layout of the API 134, to modify the application 106. For example, the user 110 may describe, in plain language, the modification 112 that the user 110 wants make to the application 106. AMS 102 may then interpret the instruction 108, and make a corresponding modification 112 to the application 106 on behalf of the user 110.

Application 106 may include any computer program, application, web application, or app, that includes user facing functionality which may be updated or modified by the user 110. In some embodiments, application 106 may include an application operating in a cloud or other network-based environment, which may be accessible to one or more users 110. In some embodiments, the application 106 may be updated, customized, or modified through making one or more application programming interface (API) calls (API call 140).

An application programming interface (API) 134 may include a set of rules and tools that allow software applications (e.g., such as application 106) to communicate with each other. API 134 may define methods and data forms that application 106 uses to request, exchange, and/or process information. In some embodiments, API 134 may be used to modify application 106 or its behavior/operations. For example, API 134 may be used to modify settings, configuration files, or preferences of application 106. In some embodiments, API 134 may be used to extend or modify an application 106, allowing a user 110 to add custom features, including modifications to data objects 120.

For simplicity, the primary example of a modification 112 described herein is focused on updating a data object 120, however it is understood that in embodiments, the modification 112 may include any update that may be made through the use of API 134 and making one or more API calls 140.

In some embodiments, API 134 may be connected to a database (not shown) accessed by the application 106, and may allow user 110 to modify classes or data objects 120 of the application 106. In some embodiments, API 134 may allow a user to enable or disable various features of application 106. In some embodiments, API 134 may include controls that prevent unauthorized or harmful modifications are not made by user 110. As used herein, modification 112 may refer to any change to any aspect of application 106 as made through one or more API calls 140.

As referenced above, a user 110 may want or need to modify an application 106 they are using, to which they have access, or to which other users are accessing (e.g., such as their team in an organization). However, performing such modifications, even when using API 134, requires a technical understanding of the API 134, which would make any such modifications beyond the reach of most end users. However, AMS 102 allows user 110 to make a modification 112 to application 106 without such technical understanding. User 110 may simply speak in plain language, the instruction 108 describing the change(s) they desire to make and AMS 102 may perform all the technical functionality required to modify the application 106, by generating one or more API calls 140.

Upon receiving the instruction 108 from user 110, a prompt generator 114 may generate one or more prompts for LLM 104 to perform some functionality involved in generating a response to the instruction 108. A prompt may include one or more lines of text organized across one or more documents that is particularly formatted to by understandable by a large language model (LLM) 104. LLM 104 may include an artificial intelligence, machine learning, or deep learning model that is configured to execute data processing commands from plain-text (e.g., not requiring computer language or coded input). LLM 104 may include any computing system that is configured to perform processing tasks based on text-based or plain language inputs. LLM 104 may be configured to create original content from one or more documents or input in accordance with a prompt. In some embodiments, LLM 104 may include a generative pre-training transformer (GPT).

Example prompts which may be generated by prompt generator 114 include a vector prompt 116 and API prompt 126. In other embodiments, different or additional prompts may be generated.

In some embodiments, the vector prompt 116 may be used to cause LLM 104 to interpret or translate the instruction 108 into one more technical commands and/or extract keywords that are associated with the modification 112 being requested by user 110. Because the user 110 may use natural language in instruction 108, the instruction 108 may include words that are not directly associated with new functionality (such as “I want to add new functionality that . . . ”). The vector prompt 116 may cause LLM 104 to strip away the words that are not directly associated with the modification 112 being requested by user 110, and identify more precisely what modification 112 the user 110 is requesting.

In some embodiments, the vector prompt 116 may include the instruction 108 as input, and may request LLM 104 to generate as output a vector 118. Vector 118 may include a translation of the instruction 108 into one or more technical commands and/or keywords. LLM 104 may be trained to perform initial NLP (natural language processing) on the instruction 108 provided by user 110 to generate the vector 118. Through leveraging the capability to LLM 104 to understand or translate natural language, AMS 102 allows a user 110 without any technical background or understanding of application 106 and/or API 134 to update application 106 in accordance with API 134.

In some embodiments, vector 118 may be used by AMS 102 to identify which application(s) 106, data object(s) 120, and API(s) 134 are relevant to executing the modification 112 to application 106, as defined by instruction 108. For simplicity, FIG. 1 illustrates a single application 106, API 134, and data object 120. However, it is understood that AMS 102 may have access to any number of applications 106, APIs 134, and data objects 120 (e.g., each application 106 may have its own unique API 134, and corresponding set of data objects 120). And because instruction 108 may not include such technical information, AMS 102 may identify which application(s) 106, data object(s) 120, and API(s) 134 are relevant to fulfilling the user instruction 108.

In some embodiments, API 134 may be the actual implementation or service that enables software to interact with another system, and may include endpoints, methods, and data formats. The specification 128 may be a detailed formalized description of what API 134 does and how it works. Specification 128 may include rules for interacting with the API 134, but does not provide the actual implementation. In some embodiments, each application 106 may have its own API 134, and each API 134 may have its own specification 128. For simplicity, only a single specification 128 is illustrated, however it is understood that vector database 130 may include any number of specifications 128. Vector database 130 may include a library or other storage of a plurality of specifications 128.

In some embodiments, AMS 102 may perform authentication 142 of user 110. Authentication 142 may include verifying the identity of the user 110 and identifying or retrieving permissions granted to the user 110. The permissions may indicate which application(s) 106 the user is authorized to access and/or modify, and what modifications 112 the user 110 is authorized to make.

In some embodiments, AMS 102 may compare vector 118 to permissions retrieved as part of authentication 142, to determine whether or not the user 110 is authorized or permitted to perform the requested modification 112, as indicated by instruction 108. If the user 110 is not authorized, AMS 102 may return a message to user 110, via user interface 124, indicating that the user 110 is not authorized to perform such a modification 112.

In some embodiments, AMS 102 (which may include the operations of LLM 104) may narrow the scope of what application(s) 106 are referred to in instruction 108 based on authentication 142. For example, AMS 102 may be configured to modify one hundred different applications 106. However, user 110 may only be authorized to access and modify four applications. As such, AMS 102 may narrow the scope of what applications 106 are referred to in instruction 108, if not specifically identified, based on what applications 106 the user 110 is authorized to access and modify. For example, the instruction “add a new field to the sales order document” may be ambiguous especially if multiple applications 106 include sales order documents. Rather than searching one hundred different possible applications 106, AMS 102 may focus on only the four applications which user 110 is authorized to access (as determined through authentication 142).

For example, instruction 108 may be “I want to add data a sales region data field to the sales order document”. The resultant vector 118 may include the keywords of: ‘sales region’ and ‘sales order document’. In some embodiments, AMS 102 may then perform a search on a vector database 130 for any specifications 128 that include vector 118.

In some embodiments, AMS 102 may perform a similarity search in searching for vector across specifications 128. The similarity search may be performed using Euclidean distance, Cosine distance, Manhattan distance, Jaccard distance, or Mahalanobis distance to compare the similarity between vector 118 and a specification 128 in vector database 130. The identified specification(s) 128 may be returned as search result 132, which may satisfy a similarity threshold or may be deemed the ‘most similar’ to vector 118. For example, the specification(s) 128 included in search result 132 may include one or more of the terms of vector 118.

In some embodiments, search result 132 may include or identify multiple specifications 128 corresponding to multiple applications 106, which the user 110 may be authorized to modify. For example, there may be three different specifications 128 that include a ‘sales order’ definition for a corresponding data object 120. To resolve this ambiguity, AMS 102 may identify the corresponding applications 106 and prompt the user 110 for a selection 136 as to which of the application(s) 106 the user 110 intends to update or modify. The user 110 may then select one or more of the applications 106.

Once a specification 128 has been identified and the corresponding data object definition for the data object 120 to be updated or modified has been identified from the specification 128, LLM 104 may extract requirements 138 from the specification 128. The requirements 138 may identify what information is required to perform the modification 112 identified from the instruction 108.

In some embodiments, the requirements 138 may indicate what information is still required from the user 110 in order to perform the modification 112. AMS 102 may prompt user 110 for the missing information as indicated by requirements 138, and receive feedback 115. Feedback 115 may include any supplemental input provided by user 110 in addition to the original instruction 108.

If selection 136 includes multiple applications 106, then LLM 104 may generate requirements 138 for each corresponding specification 128 or an accumulated set of requirements 138. One advantage of the accumulated set of requirements 138 is that, two different specifications 128 may include or require, at least in part, overlapping definitions. For example, creating a new data field for a sales region may require a ‘data type’ or ‘default value’ in two different specifications 128. Thus, rather than asking for this information twice from user 110, AMS 102 may receive the information once in feedback 115 and apply to both specifications 128.

In some embodiments, once all the required information, as indicated by requirements 138, is received from the user 110 as feedback 115, prompt generator 114 may generate an API prompt 126. In some embodiments, API prompt 126 may include vector 118, requirements 138, feedback 115 as input, and request LLM 104 to generate an API call 140. LLM 104 may then use the feedback 115 in accordance with the specification 128 to generate one or more API calls 140 for an application 106.

In some embodiments, the API call 140 may include both a payload portion and an API portion. The API portion may simply be a pointer, link, or reference to one or more commands or functionality from API 134 which are to be used to invocated with the payload portion. In some embodiments, the API function may include various parameters or variables for which a user is to provide values. These values may be stored in the payload portion of API call 140.

For example, user instruction 108 may be “I want to create a custom field for purchase order document which should store “Purchase Department” and only values like “Finance/Logistics” with defaulting as “Finance”. Through the various processes described above, LLM 104 (in processing API prompt 126) may generate the following example payload as part of the API call 140 for the example instruction 108.
{
“DefaultValue”: “Finance”,
“Description”: “Purchase Department”,
“Mandatory”: “tNO”, [indicating the field is not mandatory]
“Name”: “PurchDept”,
“Size”, 10,
“TableName”: “OPOR”,
“Type”: “db_Alpha”,
“ValidValuesMD”: [“Finance”, “Logistics”]
}

The payload structure provided above, with its particular fields and values is provided as a non-limiting example. It is understood that in other embodiments, the payload portion of API call 140 may include any different structure. For example different specification 128 and different API functionality may provide for different payload structures (e.g., variables, values, parameters, etc.). In some embodiments, AMS 102 may provide the payload to the 110 and provide the user 110 for review, and provide the user 110 the option of creating the new field in accordance with the payload, changing the payload (e.g., by using natural language/voice commands), or cancelling the request.

In some embodiments, LLM 104 may execute the API call 140 for the selected application(s) 106, perform the requested modification 112, and provide a message to the user 110 indicating that the modification 112 has failed or succeeded to the selected application(s) 106. If the selection 136 includes multiple applications 106, then AMS 102 may perform the modification 112 to the multiple applications 106, and return a result of each update or modification to the user 110.

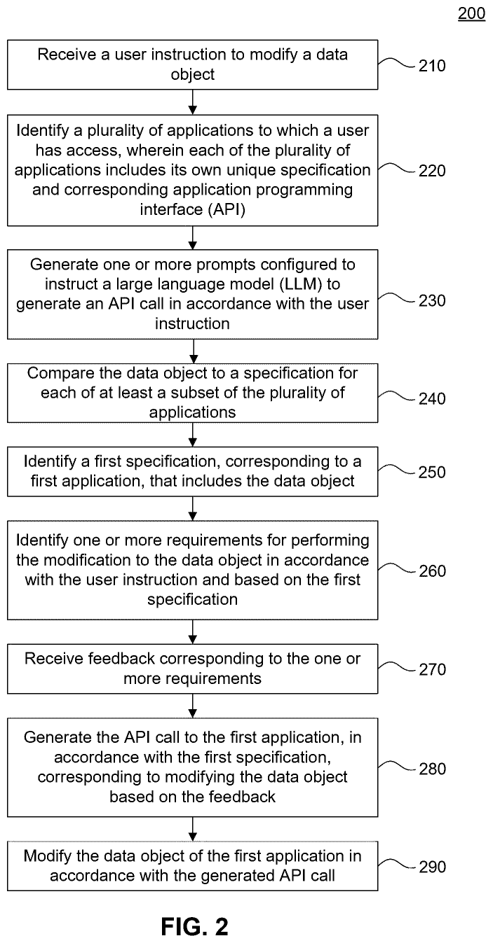

FIG. 2 is a flowchart 200 illustrating example operations for providing an application modification system (AMS) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1.

In 210, a user instruction to modify a data object is received. For example, AMS 102 may receive instruction 108 from user 110, via interface 124. Instruction 108 may include any modification to application 106, which may be performed through one or more API calls 140, including but not limited to modifying a data object 120 of application 106. Data object 120 may include a self-contained unit of data that represents an entity or concept and may include both attributes or properties and methods. In some embodiments, data object 120 may include any structured information.

In 220, a plurality of applications to which the user has access are identified. For example, AMS 102 may perform an authentication 142 and identify a set of applications 106 which the user 110 is authorized to access or modify. Each application 106 may include its own API 134 and corresponding specification 128 (e.g., for using the API 134 to perform one or more modifications 112 to the application 106 and/or its data objects 120).

In 230, one or more prompts configured to instruct a large language model (LLM) to generate an API call in accordance with the user instruction are generated. For example, prompt generator 114 may generate a vector prompt 116 for instructing LLM 104 to generate a vector 118, and an API prompt 126 for instructing LLM 104 to generate an API call 140.

In 240, the data object is compared to a specification for at least a subset of the plurality of applications. For example, vector 118 may include keywords or phrases that are extracted or derived from instruction 108, which may include the identification of a data object 120 which is to be modified or updated. AMS 102 may perform a similarity search, comparing the vector 118 (e.g., including the identified data object 120) to a set of specifications 128 to identify which specification(s) 128 include the data object 120 (and/or other keywords from the vector 118).

In 250, a first specification corresponding to a first application, that includes the data object, is identified. For example, vector database 130 may return a search result 132 identifying a specification 128 which includes or is the closest match to the vector 118. This specification 128 may correspond to a particular application 106 (from a suite of applications) to which the user 110 has access.

In 260, one or more requirements for performing the modification to the data object in accordance with the user instruction are identified from the first specification. For example, the specification 128 may include particular rules, guidelines, formats, and/or other requirements 138 that are necessary to modify the identified data object(s) 120. In some embodiments, prompt generator 114 may generate a requirements prompt (not shown) providing one or more specifications 128 (from search result 132 and/or selection 136) as input, and instructing LLM 104 to identify the requirements 138 from the one or more specifications 128. The requirements 138 may indicate what information is necessary and still needed from a user 110 to perform the identified modification 112 (e.g., update to the data object 120).

In 270, feedback corresponding to the one or more requirements is received. For example, AMS 102 may prompt the user 110 to provide feedback 115 that includes any additional or missing information that is necessary, per requirements 138, to perform the modification 112.

In 280, the API call to the first application is generated in accordance with the first specification, for modifying the data object based on the feedback. For example, prompt generator 114 may generate the API prompt 126 providing the specification 128, vector 118, feedback 115, requirements 138, and other information as input, instructing LLM 104 to generate one or more API calls 140 to perform modification 112.

In 290, the data object of the first application is modified in accordance with the generated API call. For example, AMS 102 may execute the API call(s) 140 and perform the modification 112 to the data object(s) 120 of one or more applications 106, in accordance with instruction 108. In some embodiments, AMS 102 may provide a result to the user 110 indicating a success or failure of the modification 112.

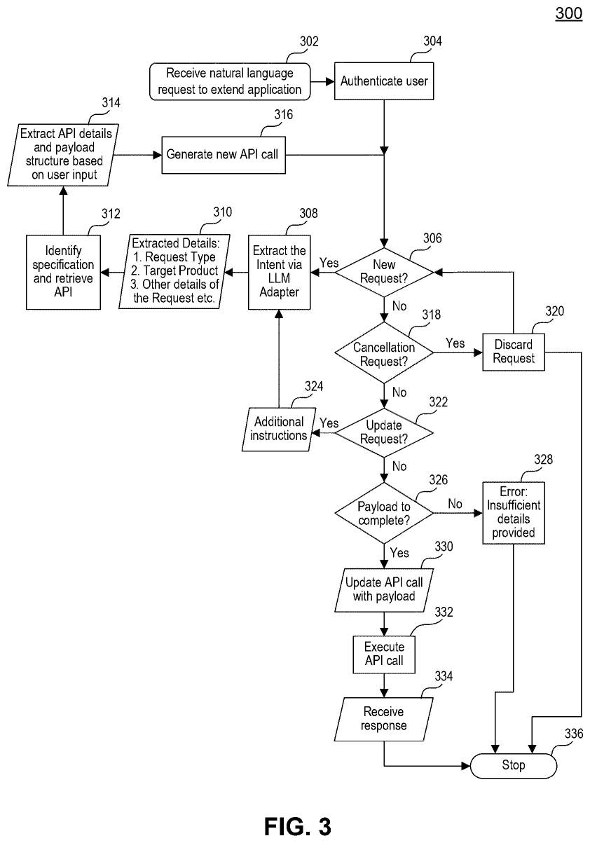

FIG. 3 is another flowchart 300 illustrating example operations for providing an application modification system (AMS) 102, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIG. 1.

At 302, AMS 102 may receive an instruction 108 from a user 110. The instruction 108 may include natural language request (e.g., spoken or text) to extend or add functionality to an existing application 106.

At 304, AMS 102 may perform user authentication. The user authentication may include AMS 102 verifying a user identity, and confirming which application(s) 106 the user 110 has authorization to update.

At 306, AMS 102 may determine whether the request is a new request. If yes, processing continues to 308. At 308, the instruction 108 may be provided to LLM 104 to decipher the intent of the user 110 or what the user 110 is instructing AMS 102 to do. The intent may include identifying which application 106 the user 110 intends to update. At 310, in response to one or more prompts from prompt generator 114, LLM 104 may extract various details from instruction 108 such as request type, target product or application, and other details of the request (e.g., what functionality is to be updated, any default values, etc.).

At 312, AMS 102 may identify a specification 128 corresponding to the identified application 106, and retrieve or otherwise access the corresponding API 134. At 314, the API 134 may be analyzed (by LLM 104 and/orAMS 102) and details, including the payload structure, may be identified and extracted from the API 134. At 316, a new API call may be generated by LLM 104.

At 306, if there is not new API call be generated, processing may continue to 318. At 318, AMS 102 may determine whether the instruction 110 is a cancellation request. If yes, at 320, the corresponding and previously generated API call may be discarded. If no, at 322, AMS 102 may determine whether the instruction is to update an existing and previously generated API call. If yes, at 324, additional details may be received from user 110 (if necessary) and the corresponding API call may be updated accordingly. If no, at 326, AMS 102 may determine if the payload (of API call 140) is complete. If no, then an error may be issued to the user 110. In some embodiments, the user 110 may be prompted to provide additional details or instructions which may then be received and the payload may be updated in accordance with processing at 324.

At 330, the API call 140 may be updated with the payload that was generated (including the details and values of various parameters received from the user 110). At 332, the API call 140 may be executed against the application 106 to perform the update or add the extension. At 334, a response may be received from the application 106 indicating a failure or success of the execution of the API call 140. This success/failure message may be communicated to the user 110, and processing may complete at 336.

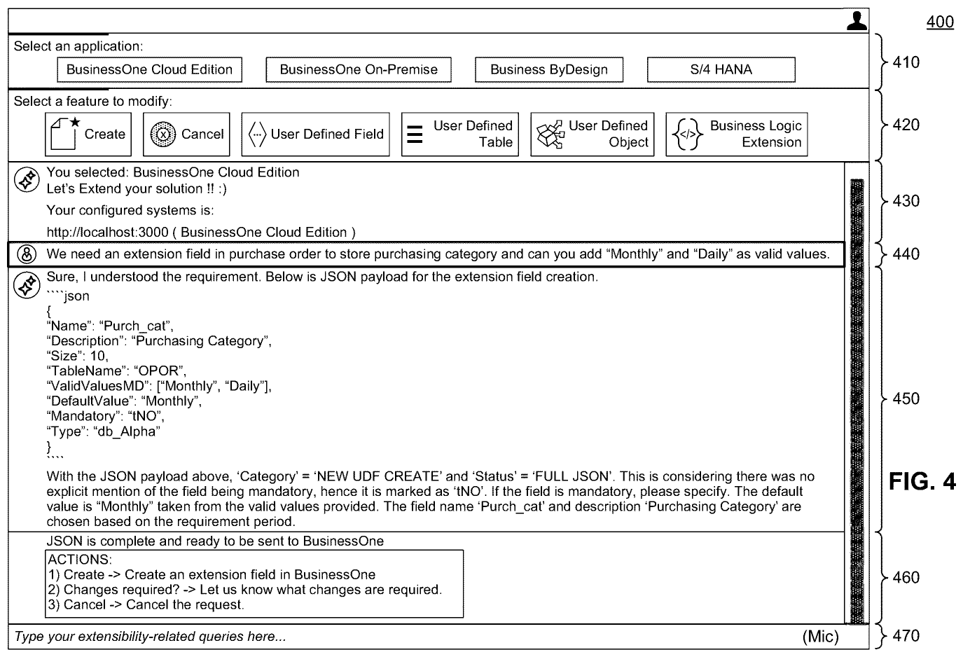

FIG. 4 is example user interface 400 for providing functionality of an application modification system (AMS) 102, according to some embodiments. User interface 400 is an example embodiment of the interface 124 illustrated in FIG. 1, which may provide for communications between AMS 102 and a user 110. The user interface 400 is described with respect to various exemplary sections or portions, however it is understood that in other embodiments, the user interface 400 may include different sections or portions and may be arranged in a different order than described herein.

In section 410, AMS 102 may prompt the user 110 to select an application 106 to modify. In some embodiments, the listed applications may only include those applications which the user 110 is confirmed to have authorization to modify.

In section 420, AMS 102 may prompt the user to select a feature to modify. The example options may include various modifiable sections or portions of the selected application (from section 410), and may allow the user to create a new custom modification (if what they want to do is not listed), or cancel (if they change their mind and don't want to modify anything).

In section 430, AMS 102 may provide output to the user confirming their selections in section 410 and/or 420.

Section 440 may be a user command line where the user may type or speak a (plain language) instruction 108 to AMS 102.

Section 450 illustrates an example output of an API call 140 as generated by AMS 102. Section 460 illustrates example actions that may be performed or selected by the user including, create the extension by executing the API call 140 of section 450, changing the API call 140, and cancelling the request. In section 470, the user may type or speak their response, or enter a new query.

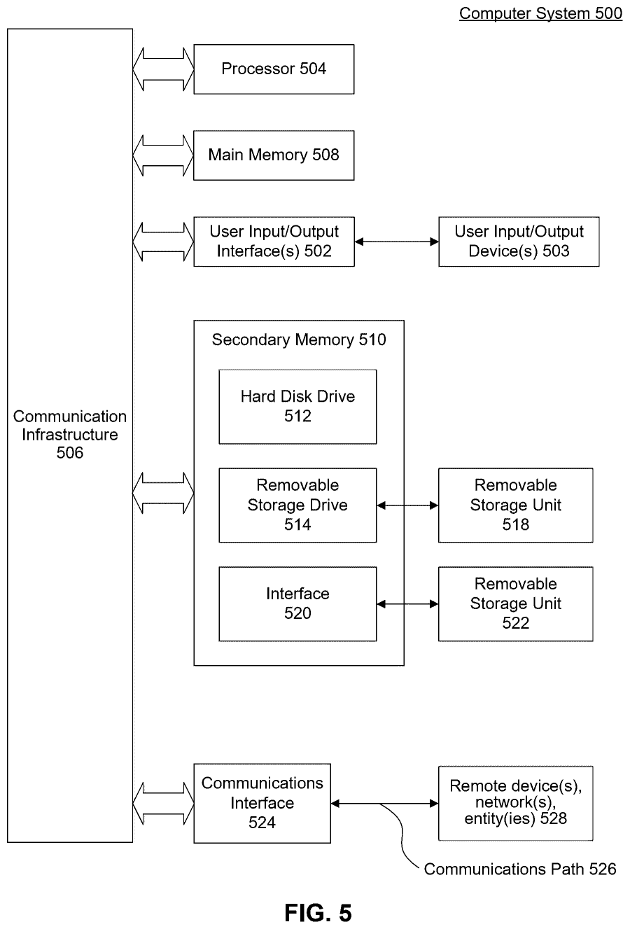

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving, from a user, a user instruction to modify a data object;
identifying a plurality of applications to which the user has access, wherein each of the plurality of applications includes its own unique specification and corresponding application programming interface (API);
generating one or more prompts configured to instruct a large language model (LLM) to generate an API call in accordance with the user instruction, wherein the LLM is configured to perform the following operations in accordance with the one or more prompts:
compare the data object to the specification for at least a subset of the plurality of applications;
identify, based on the comparison, a first specification corresponding to a first application, of the plurality of applications, that includes the data object;
identify, from the first specification, one or more requirements for performing the modification to the data object in accordance with the user instruction;
receive, from the user, feedback corresponding to the one or more requirements; and
generate the API call to the first application, in accordance with the first specification, corresponding to modifying the data object based on the feedback; and
modifying the data object of the first application in accordance with the generated API call.

2. The computer-implemented method of claim 1, further comprising:
prompting the user to provide the feedback corresponding to the one or more requirements.

3. The computer-implemented method of claim 1, wherein the identification based on the comparison comprises:
identifying a plurality of specifications, each of which includes the data object, wherein the plurality of specifications each corresponds to a different one of the plurality of applications; and
prompting the user to select one or more of the plurality of applications for modifying the data object.

4. The computer-implemented method of claim 3, wherein the user selects both the first application and a second application of the plurality of applications.

5. The computer-implemented method of claim 4, wherein the one or more requirements correspond to both the first specification of the first application and a second specification of the second application.

6. The computer-implemented method of claim 5, wherein the modifying comprises modifying a first data object in the first application and a second data object in the second application.

7. The computer-implemented method of claim 1, wherein the modifying comprises:
providing the API call for display to the user;
receiving a modification to the API call; and
modifying the data object of the first application in accordance with the modification.

8. A system comprising:
a memory; and
at least one processor coupled to the memory and configured to perform operations comprising:
receiving, from a user, a user instruction to modify a data object;
identifying a plurality of applications to which the user has access, wherein each of the plurality of applications includes its own unique specification and corresponding application programming interface (API);
generating one or more prompts configured to instruct a large language model (LLM) to generate an API call in accordance with the user instruction, wherein the LLM is configured to perform the following operations in accordance with the one or more prompts:
compare the data object to the specification for at least a subset of the plurality of applications;
identify, based on the comparison, a first specification corresponding to a first application, of the plurality of applications, that includes the data object;
identify, from the first specification, one or more requirements for performing the modification to the data object in accordance with the user instruction;
receive, from the user, feedback corresponding to the one or more requirements; and
generate the API call to the first application, in accordance with the first specification, corresponding to modifying the data object based on the feedback; and
modifying the data object of the first application in accordance with the generated API call.

9. The system of claim 8, the operations further comprising:
prompting the user to provide the feedback corresponding to the one or more requirements.

10. The system of claim 8, wherein the identification based on the comparison comprises:
identifying a plurality of specifications, each of which includes the data object, wherein the plurality of specifications each corresponds to a different one of the plurality of applications; and
prompting the user to select one or more of the plurality of applications for modifying the data object.

11. The system of claim 10, wherein the user selects both the first application and a second application of the plurality of applications.

12. The system of claim 11, wherein the one or more requirements correspond to both the first specification of the first application and a second specification of the second application.

13. The system of claim 12, wherein the modifying comprises modifying a first data object in the first application and a second data object in the second application.

14. The system of claim 8, wherein the modifying comprises:
providing the API call for display to the user;
receiving a modification to the API call; and
modifying the data object of the first application in accordance with the modification.

15. A non-transitory computer-readable medium having instructions stored thereon that, when executed by at least one computing device, cause the at least one computing device to perform operations comprising:
receiving, from a user, a user instruction to modify a data object;
identifying a plurality of applications to which the user has access, wherein each of the plurality of applications includes its own unique specification and corresponding application programming interface (API);
generating one or more prompts configured to instruct a large language model (LLM) to generate an API call in accordance with the user instruction, wherein the LLM is configured to perform the following operations in accordance with the one or more prompts:
compare the data object to the specification for at least a subset of the plurality of applications;
identify, based on the comparison, a first specification corresponding to a first application, of the plurality of applications, that includes the data object;
identify, from the first specification, one or more requirements for performing the modification to the data object in accordance with the user instruction;
receive, from the user, feedback corresponding to the one or more requirements; and
generate the API call to the first application, in accordance with the first specification, corresponding to modifying the data object based on the feedback; and
modifying the data object of the first application in accordance with the generated API call.

16. The non-transitory computer-readable medium of claim 15, the operations further comprising:
prompting the user to provide the feedback corresponding to the one or more requirements.

17. The non-transitory computer-readable medium of claim 15, wherein the identification based on the comparison comprises:
identifying a plurality of specifications, each of which includes the data object, wherein the plurality of specifications each corresponds to a different one of the plurality of applications; and
prompting the user to select one or more of the plurality of applications for modifying the data object.

18. The non-transitory computer-readable medium of claim 17, wherein the user selects both the first application and a second application of the plurality of applications.

19. The non-transitory computer-readable medium of claim 18, wherein the one or more requirements correspond to both the first specification of the first application and a second specification of the second application.

20. The non-transitory computer-readable medium of claim 19, wherein the modifying comprises modifying a first data object in the first application and a second data object in the second application.
